(19) United States
(12) Patent Application Publication
(10) Pub. No.: US 2026/0044884 A1
(43) Pub. Date: Feb. 12, 2026

(54) ONLINE MALL SYSTEM

(71) Applicant: Yuko-Sangyo Co.Ltd, Hirakata-shi, Osaka (JP)

(72) Inventor: Yasuyuki SHIRAI, Hirakata-shi, Osaka (JP)

(21) Appl. No.: 18/862,154

(22) PCT Filed: Mar. 17, 2023
(86) PCT No.: PCT/JP2023/010625

§ 371 Date: Oct. 24, 2025

(30) Foreign Application Priority Data
Mar. 25, 2022 (JP) 2022-049698

(51) Int. Cl. G06Q 30/0601; G06Q 10/067

(52) U.S. Cl. CPC G06Q 30/0603; G06Q 10/0672

(57) ABSTRACT

An online mall system comprises a mall account storage portion configured to store a mall account of each of a plurality of online malls, a shop account storage portion configured to store a shop account of each of a plurality of online shops, an affiliation relationship storage portion configured to store an affiliation relationship between each of the plurality of online shops and each of the plurality of online malls.

### TECHNICAL FIELD

The present invention relates to the technology of online malls.

### BACKGROUND ART

In recent years, online shopping has become popular, and many consumers do their shopping at online shops provided on the Internet. Further, a plurality of online shops may gather to form one online mall. The online mall allows consumers to search for their desired products from the online mall, which is more convenient for the consumers than visiting individual online shops.

In addition, the following technique related to online malls has been proposed. This merchandise sales system in the Patent Literature 1 is constituted by connecting a server computer, a shop computer of an actually existing store having a virtual store on the server computer, and a user computer of a user using the virtual store on the server computer through an electronic communication network. The server computer virtually constructs a shopping mall constituted by a plurality of virtual stores in the same arrangement as the actual geographical arrangement of actual stores having the respective virtual stores, provides a landscape image showing the street of the shopping mall to the user computer, provides a landscape image in the case of moving in the shopping mall on the basis of a movement instruction from the user computer, and provides data relating to a commodity that the user desires to purchase to the shop computer on the basis of a purchase instruction from the user computer.

### CITATION LIST

### Patent Literature

Patent Literature 1: Japanese Unexamined Patent Publication No. 2008-287450

### SUMMARY OF INVENTION

### Technical Problem

To implement an online mall, at least a server computer is required as described in the Patent Literature 1. In recent years, cloud computing has become popular. However, even when cloud computing is used, a system of an online mall needs to be constructed on a cloud computer. Building such a system requires a large cost.

In view of the above-described problems, an object of the present invention is to implement an online mall at a lower cost than before.

### Solution to Problem

An online mall system according to an embodiment of the present invention includes a mall account storage means configured to store a mall account of each of a plurality of online malls, a shop account storage means configured to store a shop account of each of a plurality of online shops that can affiliate with one or more of the plurality of online malls, an affiliation relationship storage means configured to store an affiliation relationship between each of the plurality of online shops and each of the plurality of online malls, a new mall registering means configured to generate an account of a new online mall for an applicant wishing to establish the new online mall and register the new online mall as one of the plurality of online malls by storing the generated account as the mall account in the mall account storage means, a suggesting means configured to search for a satisfying online shop that satisfies a condition specified by an extension-desired online mall among the plurality of online malls from among the plurality of online shops and suggest the satisfying online shop to the extension-desired online mall, an updating means configured to update the affiliation relationship stored in the affiliation relationship storage means so that the satisfying online shop is affiliated with the extension-desired online mall when both the extension-desired online mall and the satisfying online shop desire an affiliation.

### Advantageous Effects of Invention

According to the present invention, an online mall can be implemented at a lower cost than before.

### BRIEF DESCRIPTION OF DRAWINGS

FIG. 1 is a diagram illustrating an example of an overall configuration of an online mall system.

FIG. 2 is a diagram illustrating an example of a hardware configuration of a server.

FIG. 3 is a diagram illustrating an example of a functional configuration of the server.

FIG. 4 is a diagram illustrating an example of a relationship between online malls and the online shops.

FIG. 5 is a diagram illustrating an example of a mall attribute table.

FIG. 6 is a diagram illustrating an example of a shop attribute table.

FIG. 7 is a diagram illustrating an example of a product table.

FIG. 8 is a diagram illustrating an example of a configuration of a main domain.

FIG. 9 is a diagram illustrating an example of an affiliation table.

FIG. 10 is a diagram illustrating an example of a mall event table.

FIG. 11 is a diagram illustrating an example of a shop event table.

FIG. 12 is a diagram showing an example of an overall top page.

FIG. 13 is a diagram illustrating an example of a mall web page.

FIG. 14 is a diagram illustrating an example of a shop web page.

FIG. 15 is a diagram illustrating an example of a bulletin board management table.

FIG. 16 is a diagram showing an example of a matching web page.

FIG. 17 is a diagram illustrating an example of an offer dialog.

FIG. 18 is a diagram illustrating an example of an offer data storage module.

FIG. 19A is a diagram illustrating an example of a response dialog.

FIG. 19B is a diagram illustrating an example of a response dialog.

FIG. 20 is a flowchart illustrating an example of a flow of an overall processing of the server.

### DESCRIPTION OF EMBODIMENTS

### Overall Configuration

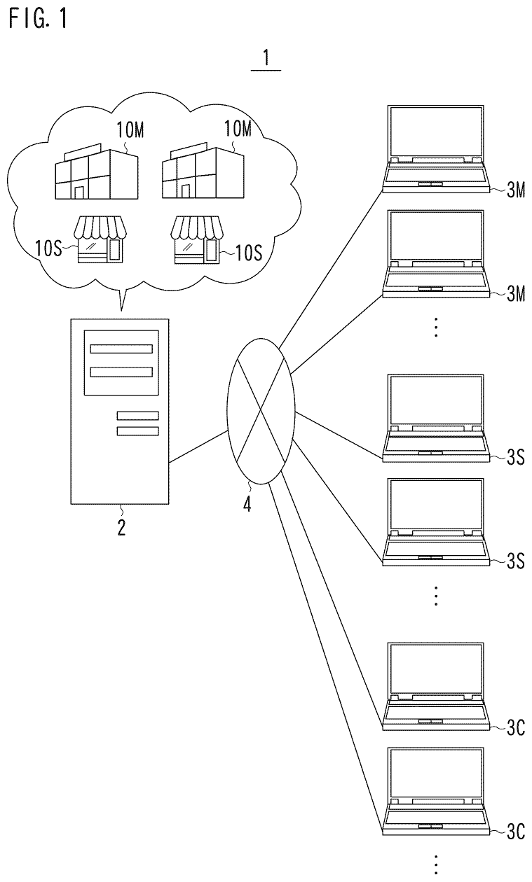

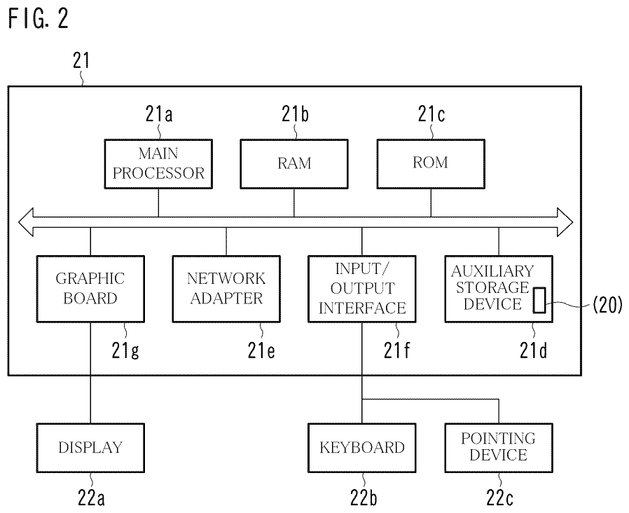

FIG. 1 is a diagram illustrating an example of an overall configuration of an online mall system 1. FIG. 2 is a diagram illustrating an example of a hardware configuration of a server 2.

The online mall system 1 shown in FIG. 1 is a system that provides a plurality of virtual shopping malls, that is, online malls on the Internet, and includes the server 2, a plurality of mall terminals 3M, a plurality of shop terminals 3S, a plurality of consumer terminals 3C, a communication line 4, and the like. An online mall may be generally referred to as an “electronic mall”.

The server 2 and each of the mall terminals 3M, each of the shop terminals 3S, and each of the consumer terminals 3C can communicate with each other via the communication line 4. As the communication line 4, the Internet, a local area network (LAN) line, a public line, or the like is used.

The server 2 provides an online mall service by managing data of each of the online malls and data of each of business entities belonging to (affiliated with) each of the online malls, and by transmitting web pages of each of the online malls and web pages of each of the business entities. The online mall service includes various services related to the online mall, such as a service for supporting operation of the online mall, a service for supporting affiliation (belonging) to the online mall, a service for supporting operation of an online shop, a service for supporting matching between the online mall and the online shop, and a service for supporting online shopping. Hereinafter, the online mall service is referred to as a “present service”.

As the server 2, a so-called server device or a cloud server is used. Hereinafter, a case where a server device is used as the server 2 will be described as an example.

A user can establish its own online mall on the server 2 by being admitted to the present service. The user may be an individual, a corporation, or an organization other than a corporation. Hereinafter, an online mall established in the server 2 is referred to as an “online mall 10M”.

Further, a business entity belonging to a certain online mall 10M may be an individual, a corporation, or an organization other than a corporation, as in the case of the establisher of the online mall 10M. In addition, it does not matter whether or not the business entity has a so-called real shop. The business entity is one of business operators of various business types that sell products or provide services, such as a general store, a secondhand shop, a grocery store, a liquor store, a sporting goods store, a cram school, a musician, an astrologer, a system engineer, and a programmer.

The business entity can establish its own website in a domain of the server 2 by being admitted to the present service, and can transact with consumers. This website works as a virtual shop (an online shop). Therefore, hereinafter, a business entity being admitted to the present service is referred to as an “online shop 10S”. Further, the domain of the server 2 is referred to as a “main domain”. A specific domain name such as “example.com” is set in advance in the main domain.

As shown in FIG. 2, the server 2 is configured by a computer main body 21, a display 22a, a keyboard 22b, a pointing device 22c, and the like. The computer main body 21 is configured by a main processor 21a, a Random Access Memory (RAM) 21b, a Read Only Memory (ROM) 21c, an auxiliary storage device 21d, a network adapter 21e, an input/output interface 21f, a graphic board 21g, and the like.

The main processor 21a is a processor such as a central processing unit (CPU) or a graphics processing unit (GPU), and executes a program loaded into the RAM 21b.

A service providing program 20 as well as an operating system is installed in the ROM 21c or the auxiliary storage device 21d. The service providing program 20 is loaded into the RAM 21b and executed by the main processor 21a. Other programs are also loaded into the RAM 21b and executed by the main processor 21a as appropriate. As the auxiliary storage device 21d, a hard disk drive (HDD), a solid state drive (SSD), or the like is used.

The network adapter 21e is a communication device such as a Network Interface Card (NIC) for communicating with a certain mall terminal 3M, a certain shop terminal 3S and a certain consumer terminal 3C. The input/output interface 21f is an input/output board corresponding to a standard such as Universal Serial Bus (USB), and the keyboard 22b and the pointing device 22c are connected thereto.

The graphic board 21g generates a video signal for displaying a screen and transmits the video signal to the display 22a. The graphic board 21g may also be referred to as a “video board” or a “video card” or the like. The display 22a is connected to the graphic board 21g and displays an image based on a video signal from the graphic board 21g.

The display 22a displays a screen for inputting a command or information, a screen showing an execution result of processing by the main processor 21a, and the like based on the video signal.

The keyboard 22b and the pointing device 22c are used to input the command or information. The command or information may be input to the server 2 by a personal computer, a tablet computer, or a smartphone via the communication line 4.

Referring back to FIG. 1, the mall terminals 3M are terminal devices used by operators of the online malls 10M in order for the online malls 10M to receive the present service. The shop terminals 3S are terminal devices used by operators of the online shops 10S in order for the online shops 10S to receive the present service. The consumer terminal 3C are terminal devices for general consumers to use the online malls 10M or the online shops 10S.

As the mall terminals 3M, the shop terminals 3S, and the consumer terminals 3C, computers having a function of connecting to the communication line 4 and a web browser, such as personal computers, tablet computers, or smartphones, are used. Hereinafter, a case where personal computers are used as the mall terminals 3M, the shop terminals 3S, and the consumer terminals 3C will be described as an example.

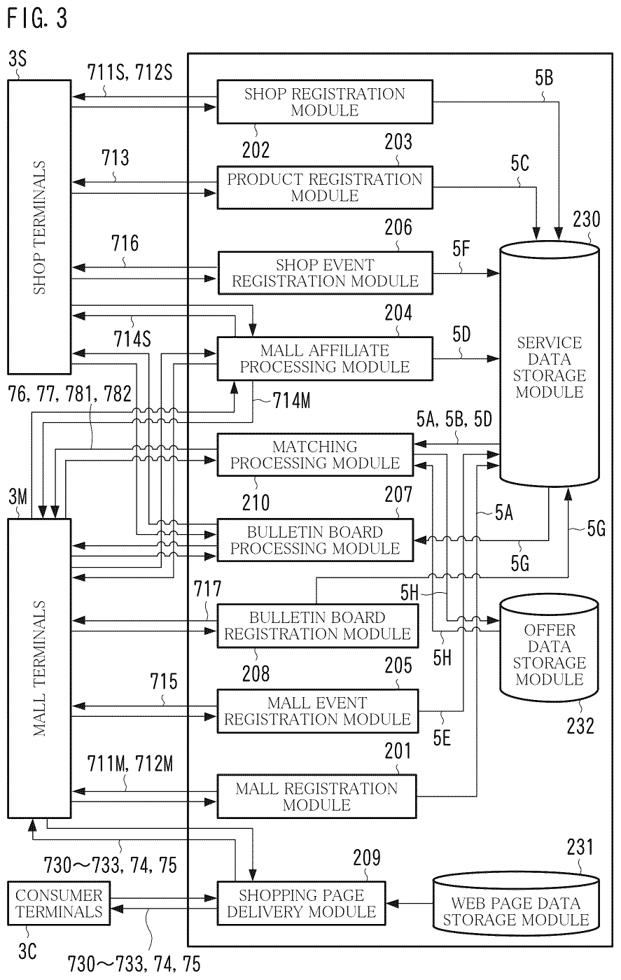

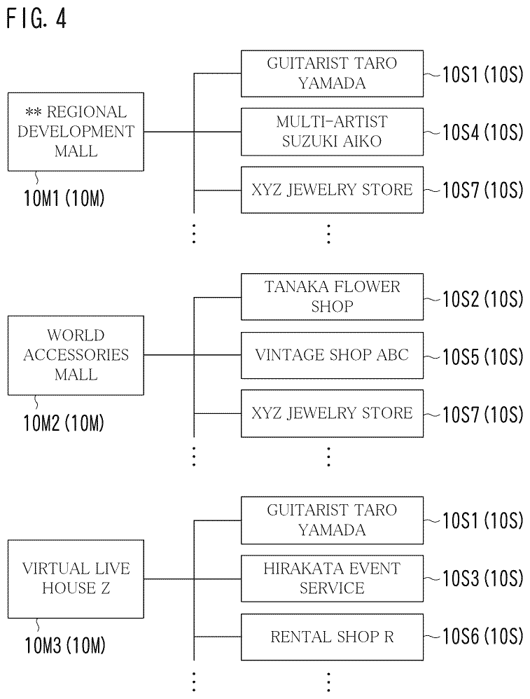

FIG. 3 is a diagram illustrating an example of a functional configuration of the server 2. FIG. 4 is a diagram illustrating an example of a relationship between the online malls 10M and the online shops 10S.

According to the service providing program 20, functions of a mall registration module 201, a shop registration module 202, a product registration module 203, a mall affiliate processing module 204, a mall event registration module 205, a shop event registration module 206, a bulletin board processing module 207, a bulletin board registration module 208, a shopping page delivery module 209, a matching processing module 210, a service data storage module 230, a web page data storage module 231, and an offer data storage module 232 illustrated in FIG. 3 are implemented. And the present service is provided by these functions.

Further, according to the service providing program 20, as shown in FIG. 4, the online malls 10M (10M1, 10M2, 10M3, . . . ) and the online shops 10S (10S1, 10S2, 10S3, . . . ) are implemented. Each of the online malls 10M has a concept. Each of the online malls 10M has its own concept according to a type of product or service which it handles, a region in which it provides its product or service, and other characteristics, such as sales of accessories in the world, sales of recycled products, mediation of barter, provision of events by collaboration of music-related persons, development of a specific region, and promotion of distribution of fair trade products.

Each of the online shops 10S can belong to an online mall 10M whose concept matches its own idea or attribute among the online malls 10M. A certain online shop 10S can belong to a plurality of the online malls 10M.

The service data storage module 230 of FIG. 3 has various data sets necessary for providing the present service. These data sets are classified into any of a plurality of tables and managed as described below.

### Basic Data Management of Online Mall 10M

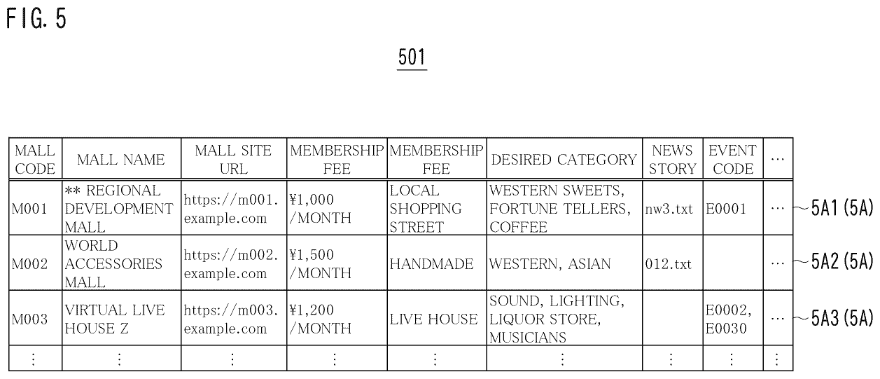

FIG. 5 is a diagram illustrating an example of a mall attribute table 501.

The service data storage module 230 has the mall attribute table 501. As shown in FIG. 5, the mall attribute table 501 stores a mall attribute data set 5A for each of the online malls 10M. The mall attribute data set 5A corresponding to a given online mall 10M indicates the following information related to the given online mall 10M.

A “mall code” is an identifier for identifying the given online mall 10M. The “mall name” is a name of the given online mall 10M. A “mall site URL” is a uniform resource locator (URL) of a website of the given online mall 10M. A “membership fee” is an operation fee paid to the given online mall 10M by an online shop 10S belonging to the given online mall 10M.

A “self-category” is a category of the given online mall 10M. It is desirable that a category corresponding to the concept of the given online mall 10M is shown as the self-category, but the given online mall 10M can freely decide the self-category. A “desired category” is a category of an online shop 10S that the given online mall 10M desires to affiliate.

A “news story” is a news story that the given online mall 10M wants to inform consumers of. The news story may be directly indicated in the mall attribute data set 5A, or a file (for example, a text file, an HTML (Hypertext Markup Language) file, or a PDF (Portable Document Format) file) for displaying the news story may be prepared in a predetermined directory, and a path or a filename of the file may be indicated in the mall attribute data set 5A. It is desirable to divide the news story into a title and a body.

An “event code” is an identifier for identifying an event held by the given online mall 10M.

Note that the mall attribute data set 5A may indicate a plurality of self-categories, a plurality of desired categories, a plurality of news stories or a plurality of event codes as necessary, or may indicate no self-categories, no desired categories, no news stories, no event codes, or none of them.

In addition, the mall attribute data set 5A indicates information on the operator of the given online mall 10M such as a name, telephone number, address, e-mail address, and SNS-ID of the operator. The SNS-ID is an identification (ID) of an account for using a predetermined Social Networking Service (SNS).

For example, a mall attribute data set 5A1 is a mall attribute data set 5A of the online mall 10M1 and indicates information on the above-described items related to the online mall 10M1 and information on the above-described items related to the operator of the online mall 10M1.

A certain mall attribute data set 5A is generated and registered in the mall attribute table 501 by the mall registration module 201 of FIG. 3 as follows.

A user who wants to establish a new online mall 10M applies for admission to the present service to the administrator of the server 2. When the admission is approved, a new mall code, password, sub-domain name, and the like are issued as a new online mall account from the administrator. Note that the user may be allowed to arbitrarily designate these pieces of information, but the mall code and the sub-domain name must be unique.

The user inputs a predetermined URL to its own mall terminal 3M and tries to access the server 2. At this time, the user logs in to the server 2 using the issued mall code and password.

Then, the mall registration module 201 transmits data of a mall registration web page 711M, which is a web page for inputting information on the new online mall 10M, to the mall terminal 3M. As a result, the mall registration web page 711M is displayed on the mall terminal 3M.

The user inputs information of the above-described items (mall name, membership fee, self-category, desired category, etc.) relating to the new online mall 10M and information of the above-described items (name, address, etc.) relating to the operator to the mall registration web page 711M. Note that, at this point, it is not necessary to input the information of all the items, and the information can be additionally input at any timing later. At least the news story and the event code cannot be inputted at this point, but are inputted later as appropriate. Also, the mall code and the mall site URL cannot be inputted.

The mall registration module 201 receives the input information from the mall terminal 3M. Then, the mall registration module 201 generates data indicating the received information, the mall code issued to the user, and a mall site URL obtained by connecting the sub-domain name issued to the user with the domain name of the main domain, and stores the data as a new mall attribute data set 5A in the mall attribute table 501.

The contents of the mall attribute data set 5A can be added, changed, or deleted later. For example, when the operator of the online mall 10M accesses a mall management web page 712M and inputs a new news story, the mall registration module 201 adds the input news story to the mall attribute data set 5A of the online mall 10M. Date and time of the addition is associated with the news story as distribution start date and time.

Note that the user (operator) of the online mall 10M logs in to the server 2 from the mall terminal 3M using its own mall code and password in advance when it operates on various web pages described later as well as the mall registration web page 711M and the mall management web page 712M. Thus, each module of the server 2 can recognize which online mall 10M the user belongs to.

### Basic Data Management of Online Shop 10S

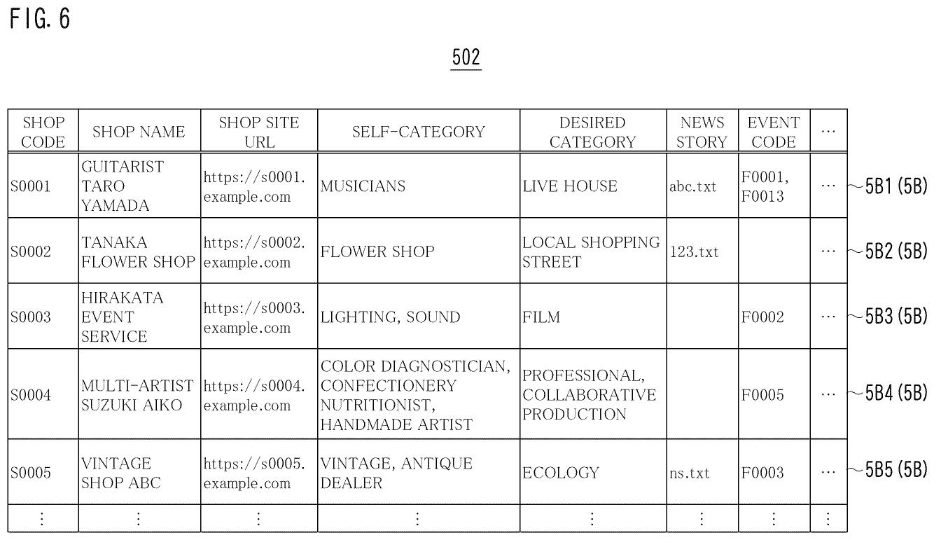

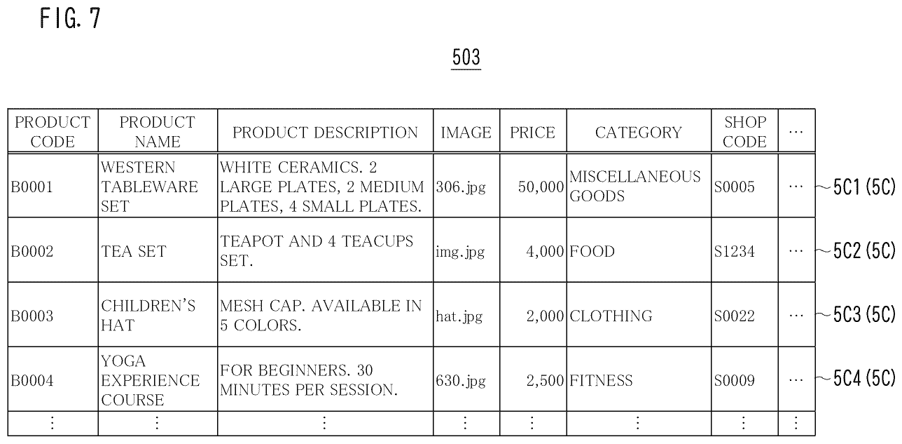

FIG. 6 is a diagram illustrating an example of a shop attribute table 502. FIG. 7 is a diagram illustrating an example of a product table 503.

The service data storage module 230 further has the shop attribute table 502 and the product table 503.

As shown in FIG. 6, the shop attribute table 502 stores a shop attribute data set 5B for each of the online shops 10S. The shop attribute data set 5B corresponding to a given online shop 10S indicates the following information related to the given online shop 10S.

A “shop code” is an identifier for identifying the given online shop 10S. A “shop name” is a name of the given online shop 10S. The name may be a personal name, a stage name or a nickname, a shop name, or a corporate name. A “shop site URL” is a URL of the website of the given online shop 10S.

A “self-category” is a category of the given online shop 10S. A category of the product or service handled by the given online shop 10S may be indicated as the self-category, or quality, target, manufacturing method, providing method, policy, or the like of the product or service may be indicated as the self-category, such as “handmade”, “home cultivation”, “no pesticide”, “student support”, or “for children”. The “desired category” is a category of the online mall 10M with which the given online shop 10S desires to affiliate.

A “news story” is information that the given online shop 10S wants to inform consumers of. As in the case of the mall attribute data set 5A (see FIG. 5), such information may be directly indicated in the shop attribute data set 5B, or a file for displaying such information may be prepared in a predetermined directory, and a path or filename of the file may be indicated in the shop attribute data set 5B. It is desirable to divide the news story into a title and a body. A plurality news stories may be indicated in the shop attribute data set 5B.

An “event code” is an identifier for identifying the event in which the given online shop 10S participates.

Note that the shop attribute data set 5B may indicate a plurality of self-categories, a plurality of desired categories, a plurality of news stories, or a plurality of the event codes as necessary, or may indicate no self-categories, no desired categories, no news stories, no event codes, or none of them. In addition, the shop attribute data set 5B indicates information on the operator of the given online shop 10S such as a name, address, e-mail address, and SNS-ID of the operator.

For example, a shop attribute data set 5B1 is the shop attribute data set 5B of the online shop 10S1 and indicates information on each of the above-described items related to the online shop 10S1 and information on each of the above-described items related to the operator of the online shop 10S1.

A cartain shop attribute data set 5B is generated and registered in the shop attribute table 502 by the shop registration module 202 as follows.

The business entity applies for admission to the present service to the administrator of the server 2. When the admission is approved, a new shop code, password, sub-domain name, and the like are issued as a new online shop account from the administrator. Note that the user may be allowed to arbitrarily designate these pieces of information, but the shop code and the sub-domain name must be unique.

The business entity inputs a predetermined URL to its own shop terminal 3S and tries to access the server 2. At this time, the business entity logs in to the Server 2 using the issued shop code and password.

Then, the shop registration module 202 transmits data of a shop registration web page 711S for inputting information on the online shop 10S of the business entity to the shop terminal 3S. As a result, the shop registration web page 711S is displayed on the shop terminal 3S.

The business entity inputs information of the above-described items (shop name, self-category, desired category, etc.) related to its own business and information of the above-described items (name, address, etc.) related to the operator to the shop registration web page 711S. Note that, at this point, it is not necessary to input information of all the items, and the information can be additionally input at any timing later. At least the news story and the event code cannot be inputted at this point, but are inputted later as appropriate. The shop code and the shop site URL cannot be inputted.

The shop registration module 202 receives the input information from the shop terminal 3S. Then, the shop registration module 202 generates data indicating the received information, the shop code issued to the business entity, and a shop site URL obtained by connecting the domain name of the main domain with the sub domain name issued to the business entity and stores the data in the shop attribute table 502 as a new shop attribute data set 5B.

The contents of the shop attribute data set 5B can be added, changed, or deleted later. For example, when the operator of the online shop 10S accesses a shop management web page 712S and inputs a new news story, the shop registration module 202 adds the input a news story to the shop attribute data set 5B of the online shop 10S. Date and time of the addition is associated with the news story as distribution start date and time.

On the other hand, as shown in FIG. 7, the product table 503 stores a product data set 5C for each of the products sold or services provided by each online shop 10S. The product data set 5C corresponding to a given product or a given service indicates the following information related to the given product or the given service.

A “product code” is an identifier for identifying the given product or the given service. A “product name” is a name of the given product or the given service. A “product description” is a description of the details of the product or service. A “image” is a path or a filename of a file of an image of the given product or an image related to the given service. A “price” is a selling price of the given product or a providing price of the given service. A “category” is a type of the given product or the given service. A “shop code” is a shop code of the online shop 10S which is a seller of the given product or a provider of the given service. In addition, various information related to the given product or the given service is shown. In addition, the product data set 5C indicates a start date of provision of the given product or the given service, a period of the provision, and the like.

These pieces of information are input by an operator in a shop terminal 3S via the product registration web page 713 delivered from the product registration module 203, and are transmitted to the server 2. And, upon receiving these pieces of information, the product registration module 203 issues a new product code, generates the product data set 5C indicating the received information and the issued product code, and stores the product data set 5C in the product table 503. Note that a list indicating a plurality of products or services may be transmitted from the shop terminal 3S to the server 2, and the product data set 5C of each of the products or services may be generated and stored in the product table 503.

Note that the operator of the online shop 10 logs in the server 2 in advance with the shop code and password of the online shop 10S when the operator operates on various web pages described later as well as the shop registration web page 711S and the shop management web page 712S. Thus, each module of the server 2 can recognize which online shop 10S the user belongs to.

### Construction of Website for Online Shopping

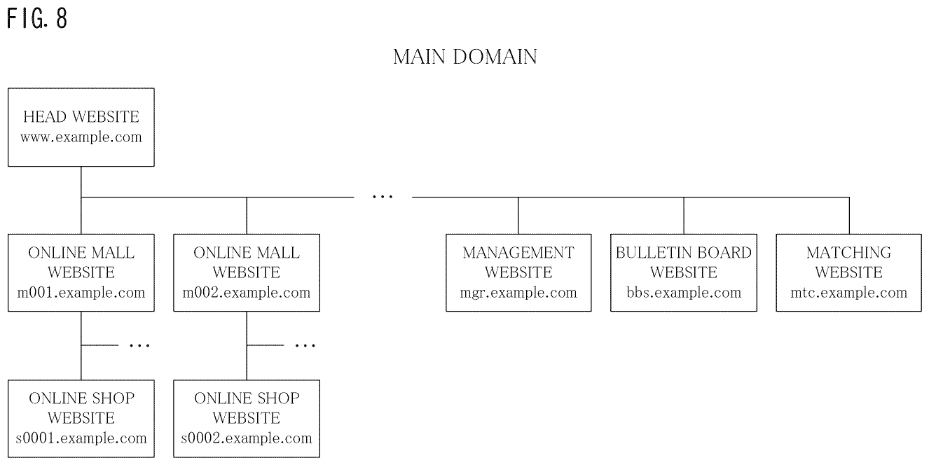

FIG. 8 is a diagram illustrating an example of a configuration of the main domain.

As described above, each online mall 10M is given a unique sub-domain name. And each online mall 10M can provide its own website in the sub-domain of its own sub-domain name in the main domain as shown in FIG. 8. Similarly, each online shop 10S is given a unique sub-domain name as described above. And each online shop 10S can provide its own website in the sub-domain of its own sub-domain name in the main domain.

When a sub-domain name of a certain online mall 10M is issued by the mall registration module 201, a dedicated folder for a website having the sub-domain name (a website of the online mall 10M) is generated in the web page data storage module 231. Thus, a storage area for the website is provided.

The operator of the online mall 10M can construct the website of the online mall 10M by uploading files of web pages of the website to the dedicated folder.

Similarly, when a sub-domain name of a certain online shop 10S is issued by the shop registration module 202, a folder dedicated to a website having the sub-domain name (a website of the online shop 10S) is generated in the web page data storage module 231. Thus, a storage area for the website is provided.

The operator of the online shop 10S can construct the website of the online shop 10S by uploading files of web pages of the website to the dedicated folder.

Note that a plurality of templates of each web page of an online mall website and a plurality of templates of each web page of an online shop website are prepared in advance. The operator of the online mall 10M or the operator of the online shop 10S can generate a file of a web page by inputting information to any one or more of these templates.

Furthermore, a head website that is a website that coordinates all the online malls 10M, the online shops 10S and the like is prepared in advance in the main domain. The head website is given a sub-domain name such as “www”. And files for each web page constituting the head website are stored in a predetermined folder.

Note that, in addition, a management website for each online mall 10M and each online shop 10 to manage their own websites is prepared in the main domain in advance. The management website is also provided with a predetermined sub-domain, and files for each web page constituting the management website are stored in a predetermined folder. The mall registration web page 711M, the shop registration web page 711S, the mall management web page 712M, the shop management web page 712S, and the product registration web page 713 described above are examples of the web pages constituting the management website. In addition, the management website has several web pages described later. Moreover, a website for an electronic bulletin board (bulletin board website) and a website for matching each online mall 10M and each online shop 10S (matching website) are prepared in advance in the main domain.

### Affiliation of Online Shop 10S to Online Mall 10M

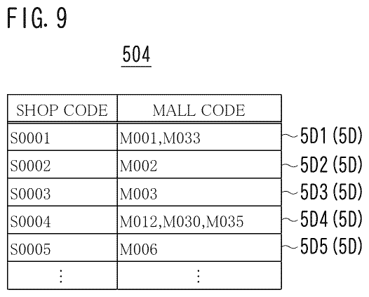

FIG. 9 is a diagram illustrating an example of an affiliation table 504.

The service data storage module 230 further has the affiliation table 504. As shown in FIG. 9, the affiliation table 504 stores an affiliation data set 5D for each online shop 10S. The affiliation data set 5D corresponding to a given online shop 10S indicates the mall code of an online mall 10M with which the given online shop 10S is affiliated in association with the shop code of the given online shop 10S. Where the given online shop 10S is affiliated with a plurality of online malls 10M, the mall codes of the respective malls are indicated. For example, an affiliation data set 5D4, which is the affiliation data set 5D of the online shop 10S4, indicates the mall codes of three online malls 10M with which the online shop 10S4 is affiliated.

The affiliation data set 5D is generated and registered in the affiliation table 504 by the mall affiliate processing module 204 as follows.

The operator of the given online shop 10S accesses an affiliate web page 714S of the management website by using its own shop terminal 3S, and designates an online mall 10M with which it wants to affiliate the given online shop 10S on the affiliate web page 714S.

Then, the mall affiliate processing module 204 performs the following registration if the approval is obtained from the designated online mall 10M.

If an affiliation data set 5D indicating the shop code of the given online shop 10S is already stored in the affiliation table 504, the mall affiliate processing module 204 adds the mall code of the online mall 10M designated in the affiliate web page 714S to the affiliation data set 5D. On the other hand, if such an affiliation data set 5D is not yet stored in the affiliation table 504, the mall affiliate processing module 204 newly generates data indicating the mall code of the designated online mall 10M and the shop code of the given online shop 10S, and stores the data in the affiliation table 504 as an affiliation data set 5D.

Alternatively, when the operator of a certain online mall 10M designates an online shop 10S that the operator wants to affiliate with the online mall 10M on an affiliate web page 714M, the mall affiliate processing module 204 performs the following registration if the designated online shop 10S approves the registration.

If an affiliation data set 5D indicating the shop code of the designated online shop 10S is already stored in the affiliation table 504, the mall affiliate processing module 204 adds the mall code of the online mall 10M to the affiliation data set 5D. On the other hand, if such an affiliation data set 5D is not yet stored in the affiliation table 504, the mall affiliate processing module 204 newly generates data indicating the mall code of the online mall 10M and the shop code of the designated online shop 10S, and stores the data in the affiliation table 504 as an affiliation data set 5D.

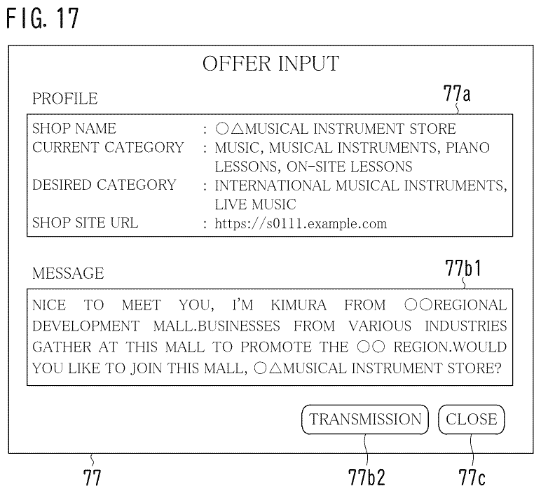

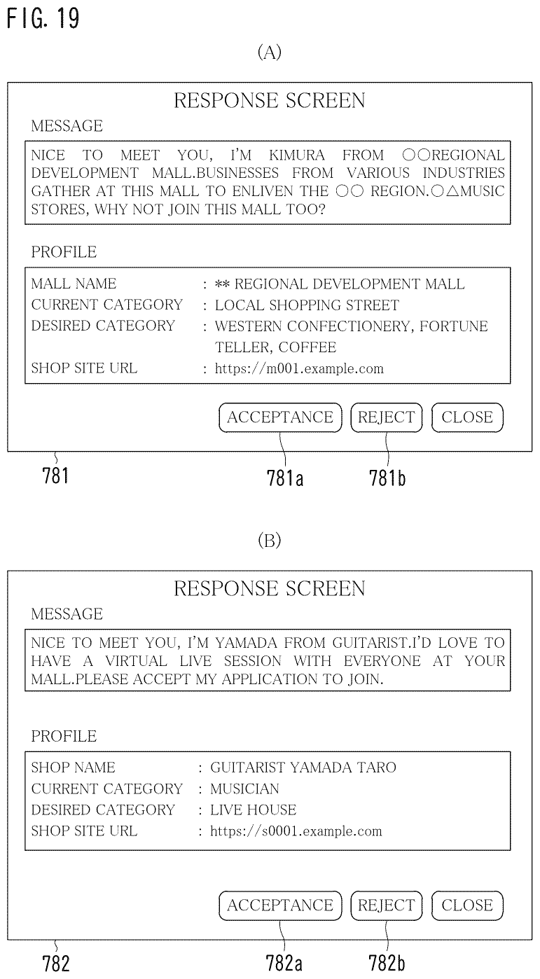

The approval from the online mall 10M or the approval from the online shop 10S can be acquired by a method using an offer dialog 77 (see FIG. 17), response dialog 781 or response dialog 782 (see FIG. 19) described later. In addition, the server 2 has a function of matching a certain online mall 10M and a certain online shop 10S. This will be described later.

### Event Registration

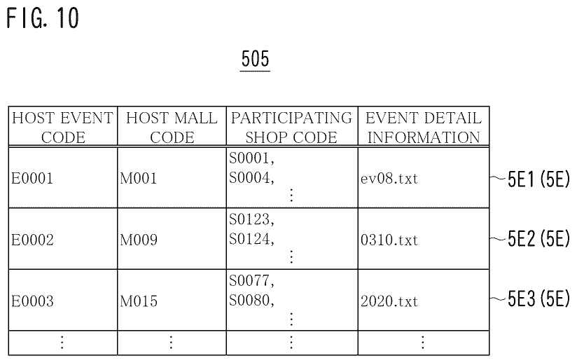

FIG. 10 is a diagram illustrating an example of a mall event table 505.

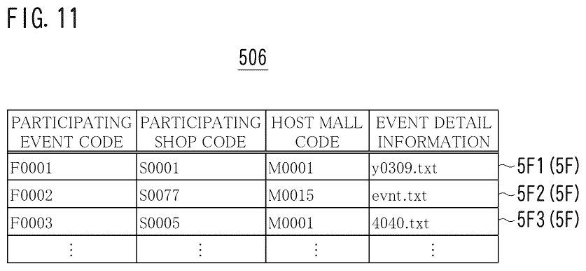

FIG. 11 is a diagram illustrating an example of a shop event table 506.

The service data storage module 230 further has the mall event table 505 and the shop event table 506.

As shown in FIG. 10, the mall event table 505 stores a mall event data set 5E for each event scheduled to be held by a certain online mall 10M. For example, the event is a bargain sale, a live concert, a talk show, a specialty products exhibition, a lottery, a new product announcement, or a consultation. The event may be held online or offline.

The mall event data set 5E for a given event indicates the following information on the given event. A “host event code” is an identifier for identifying the given event. A “host mall code” is a mall code of an online mall 10M that holds the given event. A “participating shop code” is a shop code of an online shop 10S that participates in the given event. An “event detail information” is detailed information on the given event such as a name of the given event, date and time of the given event, place of the given event, admission fee of the given event, time schedule of the given event, or outline of the given event, and is information that the online mall 10M particularly wants to convey to consumers as a position of a host of the given event. A file for displaying such information may be prepared in a predetermined directory, and a path or filename of the file may be indicated in the mall event data set 5E.

The mall event data set 5E corresponding to a given event held by a given online mall 10M is generated and registered in the mall event table 505 by the mall event registration module 205 as follows.

The operator of the given online mall 10M accesses an event registration web page 715 of the management website using its own mall terminal 3M, and inputs event detail information of the given event into the event registration web page 715. If the operator knows an online shop 10S participating in the given event, the operator designates the online shop 10S to the event registration web page 715. The operator may designate a plurality of online shops 10S.

Then, the mall event registration module 205 generates data indicating the mall code of the given online mall 10M as the host mall code, indicating the input information as the event detail information, and indicating the shop code of each of the designated online shops 10S as the participating shop code, and stores the data in the mall event table 505 as a new mall event data set 5E. Note that, when a file is input as the event detail information, the file is stored in a predetermined directory, and a path or filename of the file is indicated in the mall event data set 5E.

The mall event data set 5E is updated as appropriate in accordance with a change in the details of the given event, a change in the participating online shops 10S, or the like.

On the other hand, the shop event table 506 stores a shop event data set 5F as shown in FIG. 11. The mall event data set 5E corresponding to a given event indicates the information on the given event from a viewpoint of an online mall 10M that holds the given event as described above. the shop event data set 5F corresponding to the given event indicates information on the given event from a viewpoint of each online shop 10S that participates in the given event. Therefore, a plurality of shop event data sets 5F may exist for the same event. Specifically, the shop event data set 5F corresponding to a given event and a given online shop 10S indicates the following information.

A “participating event code” is an identifier for identifying the given event. A “participating shop code” is the shop code of the given online shop 10S. The mall event data set 5E can indicate a plurality of the participating shop codes, but the shop event data set 5F can indicate only one participating shop code. A “host mall code” is the mall code of an online mall 10M that holds the given event.

An “event detail information” is detailed information on the given event such as a name of the given event, date and time of the given event, a place of the given event, and contents of an exhibit of the given online shop 10S, and is information that the given online shop 10S wants to convey to consumers as a position of the participant of the given event. In this manner, at least a part of the content of the information may be different from the event detail information indicated by the mall event data set 5E. A file for displaying the event detail information may be prepared in a predetermined directory, and a path or filename of the file may be indicated in the shop event data set 5F.

The shop event data set 5F is generated and registered in the shop event table 506 by the shop event registration module 206 as follows.

The operator of the given online shop 10S accesses a shop event registration web page 716 of the management website by using its own shop terminal 3S, and inputs the event detail information of the given event to the event registration web page 715. Further, the operator designates the online mall 10M that holds the event in the event registration web page 715.

Then, the shop event registration module 206 generates data indicating the shop code of the given online shop 10S as the participating shop code, indicating the input information as the event detail information, and indicating the mall code of the designated online mall 10M as the host mall code, and stores the data in the shop event table 506 as a new shop event data set 5F. Note that, when a file is input as the event detail information, the file is stored in a predetermined directory, and a path or filename of the file is indicated in the shop event data set 5F.

The shop event data set 5F is updated as appropriate in accordance with a change in the details of the event or the like.

### Delivery of Web Page for Shopping

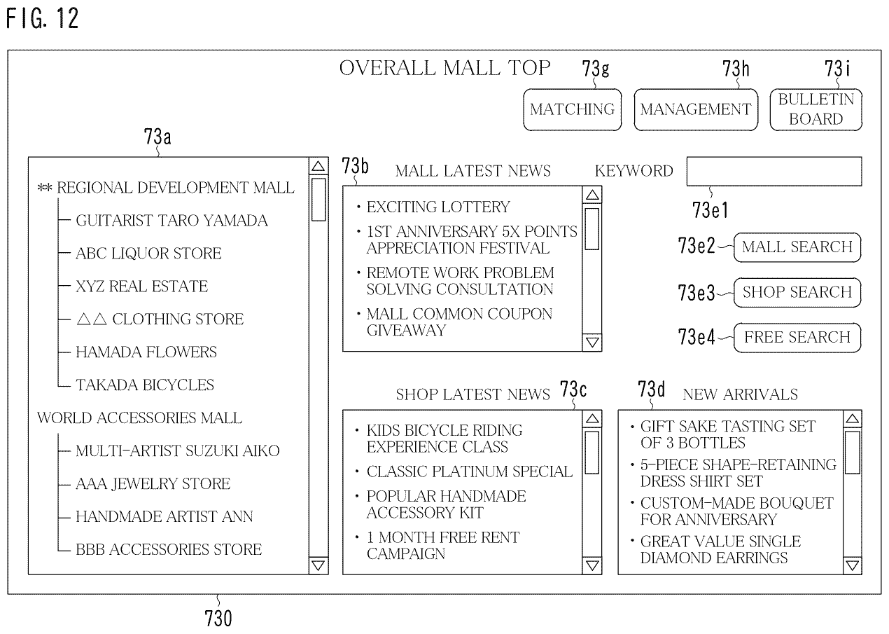

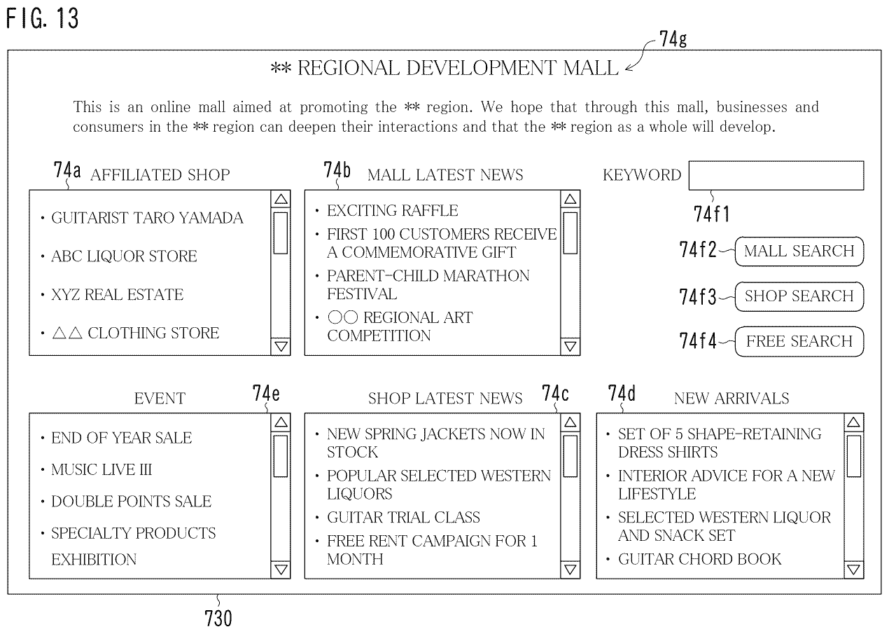

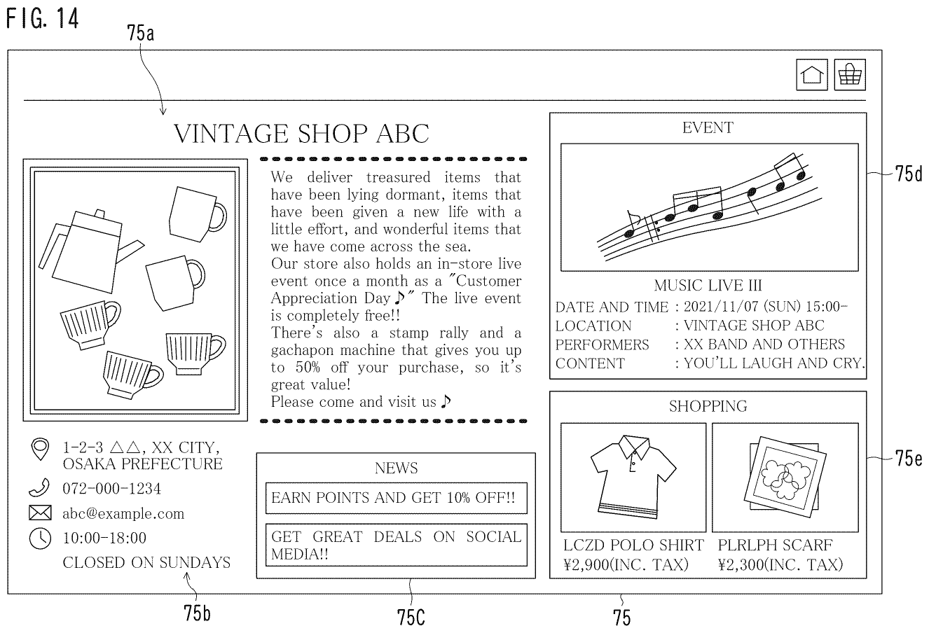

FIG. 12 is a diagram showing an example of an overall top page 73. FIG. 13 is a diagram illustrating an example of a mall web page 74. FIG. 14 is a diagram illustrating an example of a shop web page 75.

The shopping page delivery module 209 delivers a file of the web page of the head website, a file of the web page of the website of each online mall 10M, and a file of the web page of the website of each online shop 10S based on a request from a client (the mall terminal 3M, the shop terminal 3S, or the consumer terminal 3C). These web pages are web pages for shopping, and include, for example, the following web pages.

The head website is provided with the overall top page 73 as shown in FIG. 12 as one of the web pages. The overall top page 73 is a web page of a root of the head website, and is configured by the following objects.

An affiliated member area 73a shows the mall names of the online malls 10M together with the shop names of the online shops 10S which are affiliated with each of the online malls 10M in a tree structure. The mall names and the shop names are hyperlinks, and when a certain mall name is clicked, the shopping page delivery module 209 delivers a top page of the website of the online mall 10M corresponding to the clicked mall name to the client. Alternatively, when a certain shop name is clicked, the shopping page delivery module 209 delivers a top page of the website of the online shop 10S corresponding to the clicked shop name to the client.

The mall name of each of the online malls 10M is based on the mall name indicated in the mall attribute data set 5A (see FIG. 5) of each of the online malls 10M. The hyperlink to the web page of each of the online malls 10M is based on the mall site URL indicated in the mall attribute data set 5A of each of the online malls 10M. Which online shops 10S are affiliated with each of the online malls 10M can be identified by the affiliation data set 5D (see FIG. 9) stored in the affiliation table 504.

The shop name of each of the online shops 10S is based on the mall name indicated in the shop attribute data set 5B (see FIG. 6) of each of the online shops 10S. The hyperlink to the web page of each of the online shops 10S is based on the shop site URL indicated in the shop attribute data set 5B of each of the online shops 10S.

A mall news area 73b shows a predetermined number (for example ten) of news stories from among the news stories indicated by any one of the mall attribute data sets 5A, in order of delivery start date and time from the most recent. Alternatively, the mall news area 73b shows one or more news stories having delivery start date and time within the most recent predetermined period (for example, the last two days) from among the news stories indicated by any one of the mall attribute data sets 5A. Where such news stories are composed of titles and bodies, the mall news area 73b shows only the titles. When a cursor is placed on one of the titles, the body associated with the selected title is displayed in a pop-up manner. Moreover, when a news story (or its title) is clicked, the shopping page delivery module 209 delivers the top page of the website of the online mall 10M corresponding to the clicked news story or title to the client.

A shop news area 73c shows a predetermined number (for example ten) of news stories from among the news stories indicated by any one of the shop attribute data sets 5B, in order of delivery start date and time from the most recent. Alternatively, the shop news area 73c shows one or more news stories having delivery start date and time within the most recent predetermined period (for example, the last two days) from among the news stories indicated by any one of the shop attribute data sets 5B. Where such news stories are composed of titles and bodies, the shop news area 73c shows only the titles. When a cursor is placed on one of the titles, the body associated with the selected title is displayed in a pop-up manner. Moreover, when a news story (or its title) is clicked, the shopping page delivery module 209 delivers the top page of the website of the online shop 10S corresponding to the clicked news story or title to the client.

A new arrival product area 73d shows product names of a predetermined number (for example ten) of products or services from among the products or services indicated by any one of the product data sets 5C (see FIG. 7), in order of provision start date from the most recent. Alternatively, the new arrival product area 73d shows product names of products or services having provision start date within the most recent predetermined period (for example, the last two days) or being before launch from among the products or services indicated by any one of the product data sets 5C. When one of the product names is clicked, the shopping page delivery module 209 delivers the top page of the website of the online shop 10S providing the corresponding to the clicked product name to the client.

A text box 73e1 is a text box for inputting a keyword for searching for web pages in the main domain. A mall search button 73e2, a shop search button 73e3, and a free search button 73e4 are buttons for instructing execution of retrieval.

When the mall search button 73e2 is clicked, the shopping page delivery module 209 searches for web pages having the keyword inputted in the text box 73e1 from the website of each of the online malls 10M, and transmits a web page 731 showing the search result to the client.

When the shop search button 73e3 is clicked, the shopping page delivery module 209 searches for web pages having the keyword inputted in the text box 73e1 from among the website of each of the online shops 10S, and transmits a web page 732 showing the search result to the client.

When the free search button 73e4 is clicked, the shopping page delivery module 209 searches for web pages having the keyword inputted in the text box 73e1 from among the website of each of the online malls 10M and the website of each of the online shops 10S, and transmits a web page 733 showing the search result to the client.

The names (mall names or shop names) of the found online malls 10M or the found online shops 10S are arranged as hyperlinks on the web pages 731 to 733. When a certain mall name or shop name is clicked, the shopping page delivery module 209 delivers the top page of the website of the online mall 10M corresponding to the clicked mall name or the online shop 10S corresponding to the clicked shop name to the client.

A matching button 73g, a management button 73h, and a bulletin board button 73i are used by an operator of a certain online shop 10S or an operator of a certain online mall 10M. When a certain consumer terminal 3C accesses the overall top page 73, these buttons may be hidden.

When the management button 73h is clicked at a certain client, the shopping page delivery module 209 transmits a web page showing hyperlinks to the mall registration web page 711M, the shop registration web page 711S, product registration web page 713, the affiliate web page 714S, the affiliate web page 714M, the event registration web page 715, shop event registration web page 716, and a bulletin board registration web page 717 to the client. The cases when the bulletin board button 73i or the matching button 73g are clicked will be described later.

As described above, a plurality of templates of web pages for online malls and a plurality of templates of web pages for online shops are prepared, and each operator can create a web page of its own online mall 10M or its own online shop 10S using any one of these templates. Here, an example of a web page created based on these templates will be described.

The mall web page 74 shown in FIG. 13 is a top page of the online mall 10M1 created based on a certain template for online malls. The mall web page 74 is configured by the following objects.

An affiliated member area 74a shows the shop name of each online shop 10S affiliated with the online mall 10M1. The aspect that the shop name is a hyperlink and the aspect that the shop name and the URL are based on the shop attribute data set 5B are the same as in the case of the affiliated member area 73a of the overall top page 73 (see FIG. 12).

A mall news area 74b shows a predetermined number (for example ten) of news stories from among the news stories indicated by the mall attribute data set 5A of the online mall 10M1, in order of delivery start date and time from the most recent. Alternatively, the mall news area 74b shows news stories having delivery start date and time within the most recent predetermined period (for example, the last two weeks) from among the news stories indicated by the mall attribute data set 5A of the online mall 10M1. A display form of news stories and processing when a certain news story is clicked are the same as those in the case of the mall news area 73b.

A shop news area 74c shows a predetermined number (for example ten) of news stories from among the news stories indicated by any one of the shop attribute data sets 5B of online shops 10S affiliated with the online mall 10M1, in order of delivery start date from the most recent. Alternatively, the shop news area 74c shows news stories having delivery start date and time within the most recent predetermined period (for example, the last two weeks) from among the news stories indicated by any one of the shop attribute data sets 5B of online shops 10S affiliated with the online mall 10M1. A display form of news stories and processing when a certain news story is clicked are the same as those in the case of the shop news area 73c.

A new arrival product area 74d shows product names of a predetermined number (for example ten) of products of services from among the products or services indicated by the product data set 5C (see FIG. 7) of any one of the online shops 10S affiliated with the online mall 10M1, in order of provision start date from the most recent. Alternatively, the new arrival product area 74d shows product names of the products or services having provision start date within the most recent predetermined period (for example, the last two weeks) or being before launch from among the products or services indicated by the product data set 5C. A processing when a certain product name is clicked is the same as that in the case of the new arrival product area 74d.

The event area 74e shows information of one or more events before holding or during holding from among the events specified by the event code in the mall attribute data set 5A of the online mall 10M1. This information is a part (for example, an event name) of the event detail information indicated by the mall event data set 5E (see FIG. 10) indicating the event code as the host event code. When any event is selected from the event area 74e, the shopping page delivery module 209 causes the client to display all pieces of the information on the event by a dialog or a pop-up.

Roles of a text box 74f1, a mall search button 74f2, A shop search button 74f3, and a free search button 74f4 are the same as those of the text box 73e1, the mall search button 73e2, the shop search button 73e3, and the free search button 73e4 of the overall top page 73, respectively. However, while a search range on the overall top page 73 includes the websites of all the online malls 10M and the websites of all the online shops 10S, a search range on the mall web page 74 limitedly includes the website of the online mall 10M1 and the websites of the online shops 10S affiliated with the online mall 10M1.

The title area 74g shows the mall name of the online mall 10M1 and a message to the consumers. These pieces of information are input when the operator of the online mall 10M1 creates the mall web page 74 using the template.

The shop web page 75 shown in FIG. 14 is a top page of the online shop 10S5 created based on a certain one of the templates for the online shops. The shop web page 75 is configured by the following objects.

An introduction area 75a shows the shop name of the online shop 10S5 and a message to consumers, and further includes a photograph or the like that conveys an impression of the online shop 10S5. These pieces of information are input when the operator of the online shop 10S5 creates the shop web page 75 using the template.

The attribute area 75b shows information such as an address, telephone number, e-mail address, business hours, and regular holidays of the online shop 10S5. These pieces of information are also input by the operator of the online shop 10S5, as in the case of the information in the introduction area 75a. Alternatively, information indicated in the shop attribute data set 5B (see FIG. 6) of the online shop 10S5 may be used as a part of the information shown by attribute area 75b such as the address, the telephone number, and the e-mail address.

A news area 75c shows a predetermined number (for example two) of news stories from among the news stories indicated by the shop attribute data sets 5B of the online shop 10S5, in order of delivery start date and time from the most recent. Alternatively, the news area 75c shows one or more news stories having delivery start date and time within the most recent predetermined period (for example, the last one month) from among the news stories indicated by the shop attribute data sets 5B of the online shop 10S5. A display form of the news story is the same as that in the case of the shop news area 73c.

An event area 75d shows information on an event before holding or during holding from among the events indicated by the event code in the shop attribute data set 5B of the online shop 10S5. The information is the event detail information specified in the shop event data set 5F (see FIG. 11) indicating this event code as the participating event code. However, where a path or a filename is indicated in the event detail information, information indicated in a file corresponding to the path or the filename is shown in the event area 75d. Where the shop attribute data set 5B indicates the event codes of a plurality of events held before or during the meeting, the event area 75d shows the information of each of these events.

A new arrival product area 75e shows product names of a predetermined number (for example two) of products or services from among the products or services indicated by any one of the product data sets 5C (see FIG. 7) of the online shop 10S5, in order of provision start date from the most recent, together with images of the predetermined number of products or services. Alternatively, the new arrival product area 75e shows product names of one or more products or services having provision start date within the predetermined period (for example, the last one month) or being before launch from among the products or services indicated by any one of the product data sets 5C of the online shop 10S5, together with images of said one or more products or services. Note that, when a certain product name is clicked, a process for purchase is performed such that the product of the product name is registered in a virtual shopping cart of the client.

### Electronic Bulletin Board

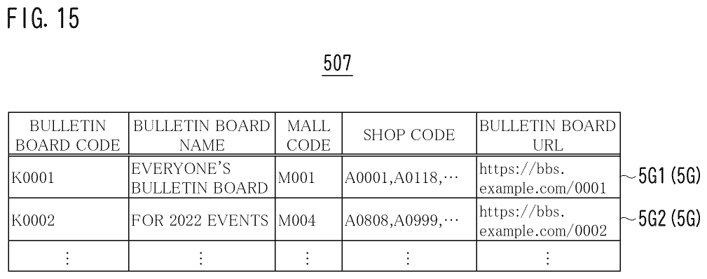

FIG. 15 is a diagram illustrating an example of a bulletin board management table 507.

As described above, the bulletin board website is provided in the main domain. And an electronic bulletin board 72 is provided by the bulletin board processing module 207.

The electronic bulletin board 72 is an electronic bulletin board for a certain online mall 10M and a plurality of online shops 10S affiliated with the online mall 10M to exchange information. Since one online mall 10M can run a plurality of electronic bulletin boards 72, the online mall 10M and some of the online shops 10S can use one of the electronic bulletin boards 72 as a bulletin board for a limited period for temporarily exchanging information.

The service data storage module 230 has the bulletin board management table 507. As shown in FIG. 15, the bulletin board management table 507 stores a bulletin board management data set 5G for each electronic bulletin board 72. The bulletin board management data set 5G indicates the following information on a given electronic bulletin board 72.

A “bulletin board code” is an identifier for identifying the electronic bulletin board 72. A “bulletin board name” is a name of the electronic bulletin board 72. A “mall code” is a mall code of an online mall 10M that runs the electronic bulletin board 72. A “shop code” is a shop code of an online shop 10S using the electronic bulletin board 72. The “bulletin board URL” is a URL of the electronic bulletin board 72.

The bulletin board management data set 5G is generated and registered in the bulletin board management table 507 by the bulletin board registration module 208 as follows.

The operator of the online mall 10M accesses a bulletin board registration web page 717 of the management website by using its own mall terminal 3M, inputs the name of the electronic bulletin board 72 which is newly established to the bulletin board registration web page 717, and designates an online shop 10S which uses the electronic bulletin board 72 among the online shops 10S affiliated with the online mall 10M. Note that the bulletin board registration web page 717 can be accessed by clicking the bulletin board button 73i on the overall top page 73 (see FIG. 12).

The bulletin board registration module 208 then issues a URL containing a new directory name for the electronic bulletin board 72. The electronic bulletin board 72 is provided in an area specified by the URL. Then, the bulletin board registration module 208 generates data indicating the mall code of the online mall 10M, the shop code of each designated online shop 10S, the input bulletin board name, and the issued URL, and stores the data in the bulletin board management table 507 as a new bulletin board management data set 5G.

In principle, a right to access the electronic bulletin board 72 is given only to the operator of the online mall 10M whose mall code is indicated in the bulletin board management data set 5G of the electronic bulletin board 72 and the operator of the online shop 10S whose shop code is indicated in the bulletin board management data set 5G.

The bulletin board processing module 207 performs processing for providing the electronic bulletin board 72 to the mall terminal 3M of the online mall 10M and the shop terminal 3S of the online shop 10S based on the bulletin board management data set 5G stored in the bulletin board management table 507. The electronic bulletin board 72 can be implemented by a known technique for an electronic bulletin board.

### Matching of Online Mall 10M and Online Shop 10S

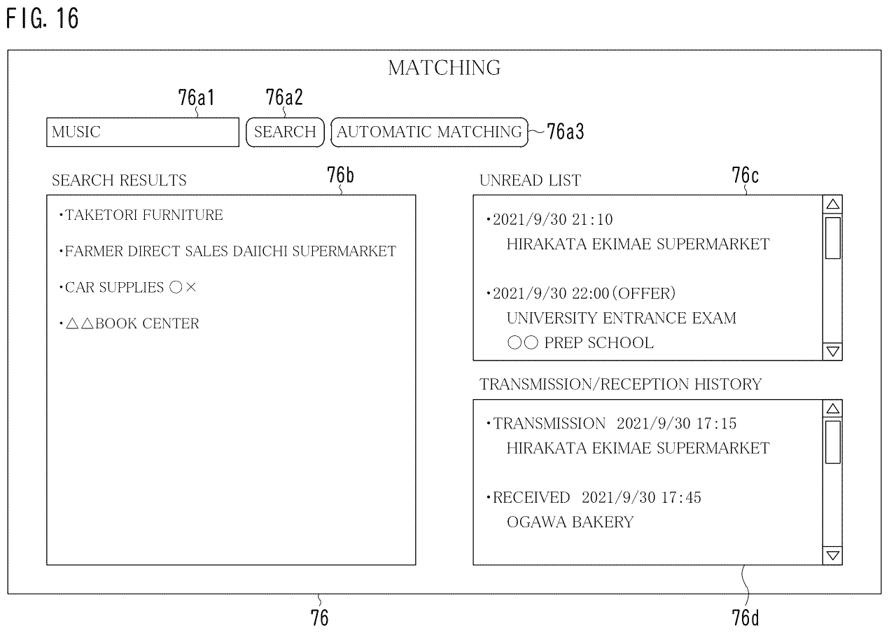

FIG. 16 is a diagram showing an example of a matching web page 76.

FIG. 17 is a diagram illustrating an example of an offer dialog 77.

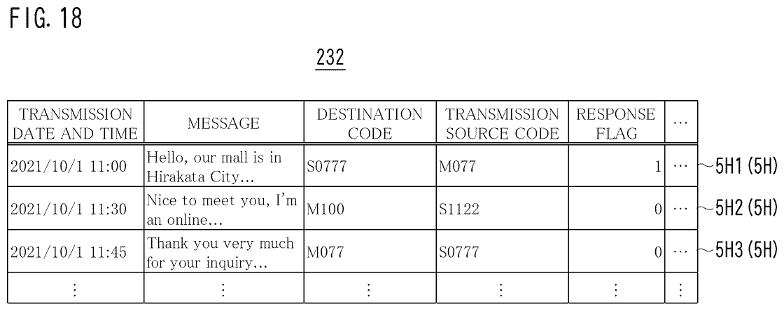

FIG. 18 is a diagram illustrating an example of an offer data storage module 232.

FIG. 19A is a diagram illustrating an example of a response dialog 781.

FIG. 19B is a diagram illustrating an example of a response dialog 782.

As described above, the matching website is provided in the main domain. An operator of a certain online mall 10M can be introduced to a partner suitable for the online mall 10M through the matching website, alternatively, an operator of a certain online shop 10S can be introduced to a partner suitable for the online shop 10S through the matching website.

The matching process is performed by matching processing module 210. Here, the matching process will be described by taking as an example a case where an operator of each of the online mall 10M1 and the online shop 10S1 uses the matching website.

### (1) Offer From Online Mall 10M1

The operator of the online mall 10M1 accesses the matching web page 76 in the matching website as shown in FIG. 16 by using its own mall terminal 3M. Note that, at the time of access to the matching web page 76, nothing is input in a text box 76a1 and nothing is shown in a search result area 76b. Further, by clicking the matching button 73g on the overall top page 73 (see FIG. 12), the operator can access the matching web page 76.

When the operator inputs a keyword in a text box 76a1 and clicks a search button 76a2, the matching processing module 210 searches the shop attribute table 502 (see FIG. 6) for the shop attribute data set 5B in which the input keyword is indicated as the self-category. Then, the shop name indicated in each found shop attribute data set 5B is arranged in the search result area 76b.

Alternatively, when the operator clicks an automatic matching button 76a3, the matching processing module 210 extracts a category indicated as a “desired category” in the mall attribute data set 5A (see FIG. 5) of the online mall 10M1. A plurality of such categories may be extracted. The matching processing module 210 searches for shop attribute data sets 5B in which any of the extracted categories is indicated as the self-category. Then, the shop name indicated in each found shop attribute data set 5B is arranged in the search result area 76b.

When the operator clicks any of the shop names in the search result area 76b, the matching processing module 210 causes the mall terminal 3M to display the offer dialog 77 as shown in FIG. 17 so as to be superimposed on the matching web page 76. A profile area 77a of the offer dialog 77 shows the information (shop name, self-category, desired category, shop site URL, etc.) of an online shop 10S corresponding to the clicked shop name. These pieces of information are indicated in the shop attribute data set 5B of the online shop 10S. The operator can access the top page of the website of the online shop 10S by clicking on the shop site URL. Note that, at the time when the offer dialog 77 is displayed, nothing is input in a text box 77b1.

The operator decides whether or not to request the online shop 10S to affiliate with the online mall 10M1 (its own online mall 10M), and if it decides to request, it inputs a message in a text box 77b1.

When the operator clicks a transmission button 77b2, the matching processing module 210 sends the input message to the e-mail address of the operator of the online shop 10S by e-mail, generates an offer data set 5H, and stores the offer data set 5H in the offer data storage module 232 shown in FIG. 18.

The offer data set 5H indicates the transmitted message, the transmission date and time, a destination code, a transmission source code, and a response flag. The destination code is an identifier of the destination of the message, and in this example, the shop code of the online shop 10S is indicated as the destination. The transmission source code is an identifier of the transmission source of the message, and in this example, the mall code of the online mall 10M1 is indicated as the transmission source code. The response flag indicates whether or not a response to the message has been made at the transmission destination, and its initial value is “0”, indicating that no response has been made yet.

After sending the message, the offer dialog 77 closes and the matching web page 76 reappears. When a close button 77c is clicked, the offer dialog 77 closes and the matching web page 76 reappears. An offer notification area 76c and a transmission/reception history area 76d will be described later.

### (2) Offer from Online Shop 10S1

On the other hand, the operator of the online shop 10S1 accesses the matching web page 76 by using its own shop terminal 3S.

When the operator inputs a keyword in the text box 76a1 and clicks the search button 76a2, the matching processing module 210 searches the mall attribute table 501 (see FIG. 5) for mall attribute data sets 5A in which the input keyword is indicated as the self-category. Then, the matching processing module 210 arranges the mall name indicated in each found mall attribute data set 5A in the search result area 76b.

Alternatively, when the operator clicks the automatic matching button 76a3, the matching processing module 210 extracts a category indicated as a “desired category” in the shop attribute data set 5B (see FIG. 6) of the online shop 10S1. A plurality of such categories may be extracted. The matching processing module 210 searches for mall attribute data sets 5A in which any of the extracted categories is indicated as the self-category. Then, the matching processing module 210 arranges the mall name indicated in each found mall attribute data set 5A in the search result area 76b.

When the operator clicks any mall name in the search result area 76b, the matching processing module 210 displays the offer dialog 77 on the shop terminal 3S so as to be superimposed on the matching web page 76. The profile area 77a of the offer dialog 77 shows the information (mall name, self-category, desired category, mall site URL, etc.) of an online mall 10M corresponding to the clicked mall name. These pieces of information are indicated in the mall attribute data set 5A of the online mall 10M. The operator can access the top page of the website of the online mall 10M by clicking the mall site URL.

The operator decides whether or not it wishes to affiliate with the online mall 10M, and if it wishes, inputs a message in the text box 77b1.

And, when the operator clicks the transmission button 77b2, the matching processing module 210 sends the input message to the e-mail address of the operator of the online mall 10M by e-mail, and generates an offer data set 5H and stores the offer data set 5H in the offer data storage module 232.

The offer data set 5H indicates the transmitted message, the transmission date and time, the destination code, the transmission source code, the response flag, and the like as in the case of (1) above. In this example, the mall code of the online mall 10M is indicated as the destination code, and the shop code of the online shop 10S1 is indicated as the transmission source code.

### (3) Offer Confirmation and Response to Offer

When the operator of the online mall 10M1 accesses the matching web page 76, a list of unresponded messages addressed to the online mall 10M1 is arranged in the offer notification area 76c. Specifically, the matching processing module 210 extracts, from the offer data storage module 232, the offer data set 5H in which the mall code of the online mall 10M1 is indicated as the destination code and “0” is indicated as the value of the response flag. Then, the matching processing module 210 arranges the transmission date and time indicated in each extracted offer data set 5H and the shop name of the online shop 10S related to the transmission source code indicated in each extracted offer data set 5H in the offer notification area 76c. The shop name is specified by the shop attribute data set 5B (see FIG. 6).

When any shop name is clicked in the offer notification area 76c, the matching processing module 210 displays a response dialog 781 as shown in FIG. 19A so as to be superimposed on the matching web page 76, the response dialog 781 showing the whole text of the message corresponding to the clicked shop name and information of the shop name on the mall terminal 3M.

If the operator approves the affiliation of an online shop 10S which is the transmission source of the message, the operator clicks an acceptance button 781a in the response dialog 781.

Then, the mall affiliate processing module 204 performs processing for causing the online shop 10S to affiliate with the online mall 10M1. That is, if the affiliation data set 5D (see FIG. 9) indicating the shop code of the online shop 10S is already stored in the affiliation table 504, the mall affiliate processing module 204 adds the mall code of the online mall 10M1 to the affiliation data set 5D. If not, the mall affiliate processing module 204 newly generates data indicating the mall code of the online mall 10M1 and the shop code of the online shop 10S and stores the data as an affiliation data set 5D in the affiliation table 504.

Thereafter, the response flag of the offer data set 5H of the message is updated to “1” indicating that a response has been made.

Alternatively, if the operator rejects the affiliation, the operator clicks a reject button 781b. Then, the response flag of the offer data set 5H of the message is updated to “1” without performing the processing for affiliation.

In the transmission/reception history area 76d, a list of messages whose destination or source is the online mall 10M1 is arranged.

On the other hand, when the operator of the online shop 10S1 accesses the matching web page 76, a list of unresponded messages addressed to the online shop 101 is arranged in the offer notification area 76c. Specifically, the matching processing module 210 extracts the offer data set 5H indicating the shop code of the online shop 10S1 as the destination code and indicating “0” as the value of the response flag from the offer data storage module 232. Then, the matching processing module 210 arranges the transmission date and time indicated in each of the extracted offer data set 5H and a mall name of an online mall 10M related to the transmission source code in the offer notification area 76c. The mall name is specified by the mall attribute data set 5A (see FIG. 5).

When any mall name is clicked in the offer notification area 76c, the matching processing module 210 displays a response dialog 782 as shown in FIG. 19B so as to be superimposed on the matching web page 76 on the shop terminal 3S, the response dialog 782 showing the whole text of the message corresponding to the clicked mall name.

If the operator of the online shop 10S1 accepts the offer from the online mall 10M1 which is a sender of the message, the operator clicks an acceptance button 782a in the response dialog 782.

Then, the mall affiliate processing module 204 performs processing for causing the online shop 10S1 to affiliate with the online mall 10M.

That is, if the affiliation data set 5D indicating the shop code of the online shop 10S1 has already been stored in the affiliation table 504, the mall affiliate processing module 204 adds the mall code of the online mall 10M to the affiliation data set 5D. If not, the mall affiliate processing module 204 newly generates data indicating the mall code of the online mall 10M and the shop code of the online shop 10S1 and stores the data as an affiliation data set 5D in the affiliation table 504.

Thereafter, the response flag of the offer data set 5H of the message is updated to “1” indicating that a response has been made.

Alternatively, if the operator rejects the offer, the operator clicks a reject button 782b. Then, the response flag of the offer data set 5H of the message is updated to “1” without performing the processing for affiliation.

In the transmission/reception history area 76d, a list of messages whose destination or source is the online shop 10S1 is arranged.

### Overall Processing Flow of Service Providing Program 20 and Effects of Present Embodiment

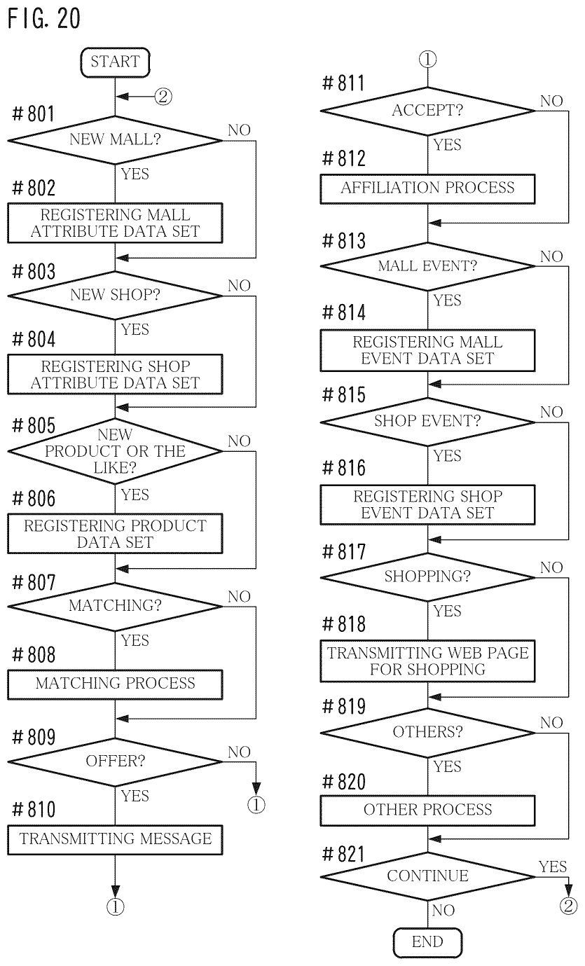

FIG. 20 is a flowchart illustrating an example of the flow of the overall processing of the server 2.

Next, the flow of the overall processing of the server 2 based on the service providing program 20 will be described with reference to the flowchart.

The server 2 performs the following processing based on the service providing program 20 in response to a request from a client (a certain mall terminal 3M, shop terminal 3S, or consumer terminal 3C).

When a user requests to be admitted to the present service as an online mall (Yes in #801 of FIG. 20), the server 2 generates a mall attribute data set 5A (see FIG. 5) for the user and registers the mall attribute data set 5A in the mall attribute table 501 (#802). Alternatively, when a user requests to be admitted the present service as an online shop (Yes in #803), the server 2 generates a shop attribute data set 5B (see FIG. 6) for the user and registers the shop attribute data set 5B in the shop attribute table 502 (#804).

Alternatively, when the server 2 is requested to register a product or the like from a certain online shop 10S (Yes in #805), the server 2 generates a product data set 5C for the product or the like and registers the product data set 5C in the product table 503 (#806).

Alternatively, when the server 2 is requested to perform matching (Yes in #807), the server 2 searches for partners who match the requester's desire and presents the found partners (#808). That is, if the requester is a certain online mall 10M, the server 2 searches for online shops 10S that match a category designated as a keyword by the online mall 10M on the matching web page 76 (see FIG. 16), and presents the found online shops 10S. Alternatively, the server 2 searches for online shops 10S that match the desired category indicated in the mall attribute data set 5A of the online mall 10M and presents the found online shops 10S. On the other hand, if the requester is a certain online shop 10S, the server 2 searches for online malls 10M that match a category designated as a keyword by the online shop 10S in the matching web page 76, and presents the found online malls 10M. Alternatively, the server 2 searches for online malls 10M that match the desired category indicated in the shop attribute data set 5B of the online shop 10S and presents the found online malls 10M.

Alternatively, when the server 2 is requested to transmit a message of an offer related to affiliation from a certain online mall 10M or online shop 10S in the offer dialog 77 (see FIG. 17) (Yes in #809), the server 2 transmits the message to the other party (#810).

Alternatively, when a certain online mall 10M or online shop 10S accepts an offer (Yes in #811), the server 2 performs processing for affiliation (#812). That is, when the offer is accepted by a certain online mall 10M, the server 2 adds the mall code of the online mall 10M to the affiliation data set 5D (see FIG. 9) of an online shop 10S which is the offer source, or newly generates an affiliation data set 5D indicating the mall code and the shop code of the online shop 10S and registers the affiliation data set 5D in the affiliation table 504. On the other hand, when the offer is accepted by a certain online shop 10S, the server 2 adds the mall code of an online mall 10M which is the offer source to the affiliation data set 5D of the online shop 10S, or newly generates an affiliation data set 5D indicating the mall code and the shop code of the online shop 10S and registers the affiliation data set 5D in the affiliation table 504.

Alternatively, when the server 2 is requested to register information on an event from a certain online mall 10M (Yes in #813), the server 2 generates a mall event data set 5E (see FIG. 10) and registers the mall event data set 5E in the mall event table 505 (#814). Alternatively, when the server 2 is requested to register information of an event from a certain online shop 10S (Yes in #815), the server 2 generates a shop event data set 5F (see FIG. 11) and registers the shop event data set 5F in the shop event table 506 (#816).

Alternatively, when the server 2 is requested to deliver a web page for shopping (for example, the overall top page 73 (see FIG. 12), the mall web page 74 (see FIG. 13), the shop web page 75 (see FIG. 14), or the like) from a consumer or the like (Yes in #817), the server 2 transmits the requested web page (#818).

In addition, the server 2 executes processing related to data update and bulletin board in response to a request (Yes in #819, #820).

The server 2 executes the processes of each of steps #801 to #820 as appropriate while providing the present service (Yes in #821).

According to the present embodiment, since the plurality of online malls 10M share the server 2, a cost for constructing and running each of online malls 10M can be reduced as compared with the conventional art. Further, by providing a function of exchanging messages related to affiliation between a certain online mall 10M and a certain online shop 10S and a function of matching partners included in a desired category, an online mall 10M can be constructed more easily than in the conventional art.

### Application Example or Modification Example

In the present embodiment, messages are exchanged via e-mails or the offer dialog 77, but may be exchanged via an SNS. In this case, the SNS-ID indicated in each of the mall attribute data set 5A and the shop attribute data set 5B may be used.

In the present embodiment, online malls 10M and online shops 10S are admitted to the present service, but consumers may be further admitted to the present service and given accounts for the consumers. At this time, the consumers register their electronic mail address and SNS-ID and categories in which they are interested. And the server 2 may distribute information matching the category of the consumers among the information on a news story and event of each online mall 10M and the information on a news story, event, product and the like of each online shop 10S to the consumers by e-mails or SNS. Examples of the SNS include LINE of LINE Corporation and Facebook of Meta Platforms, Inc.

A group for each online mall 10M may be prepared in the SNS, and an online shop 10S affiliated with the online mall 10M may be joined to the group of the online mall 10M. Alternatively, a consumer group may be prepared for each online mall 10M, and consumers may be allowed to join any consumer group as desired.

In the present embodiment, the server 2 performs matching between a certain online mall 10M and a certain online shop 10S. However, the server 2 may perform matching between the online shops 10S. That is, for example, a partner matching the online shop 10S1 may be searched from other online shops 10S. More specifically, the online shop 10S having the desired category of the online shop 10S1 as its self-category is searched (see FIG. 6). The online shop 10S1 can contact the found partner and jointly establish a new online mall 10M.

In the present embodiment, a client (mall terminal 3M, shop terminal 3S, or consumer terminal 3C) receives the present service by a web browser, but may receive the present service by installing an application dedicated to the present service in the client.

The server 2 may be provided with a function of paying the membership fee from a certain online shop 10S to a certain online mall 10M. For example, the membership fee may be paid from a certain online shop 10S to a certain online mall 10M by bank transfer, a cash card, or electronic settlement of an SNS. Alternatively, the administrator of the server 2 may collect the membership fees from each online shop 10S in a lump and pay the membership fees to each online mall 10M by the above-described method (such as bank transfer).

In the present embodiment, in the matching process, the server 2 searches for online shops 10S having, as its self-category, the category designated by a certain online mall 10M (the category indicated as the desired category in the shop attribute data set 5B (see FIG. 6) or the category input as the keyword in the text box 76a1). However, a condition of the search may be expanded as follows, for example.

The server 2 may search for online shops 10S having a category similar to the designated category as its Self-category. The similar category is a category represented by a synonym, a quasi-synonym, a superordinate concept, a subordinate concept, a related word, or the like. For example, “convenience store”, “daily product store”, “retailer”, “24-hour operation”, brand names of companies (such as “Seven-Eleven” and “Lawson”) are used as similar categories if the designated category is “CVS”. A dictionary recording a category similar to each category is prepared in advance, and the server 2 may search for such online shops 10S based on the dictionary.

In a similar manner, the server 2 may search for online malls 10M based on the category designated by a certain online shop 10S.

In the present embodiment, the server 2 searches for online malls 10M or online shops 10S based on the category in the matching process, but the server 2 may search for them based on other conditions. For example, the server 2 may search for online shops 10S under a region where a real shop is located as the condition. Alternatively, the server 2 may search for online shops 10S under a condition that shopping is possible with a specific electronic payment system.

Where a smartphone is used as a certain client, the server 2 may deliver a web page such as the overall top page 73 (see FIG. 12) with a design or the like for smartphones.

In the present embodiment, the event information of a certain online mall 10M (see FIG. 5) is posted on the web page of the online mall 10M itself (for example, the mall web page 74 in FIG. 13), and the event information of a certain online shop 10S (see FIG. 5) is posted on the web page of the online shop 10S itself (for example, the shop web page 75 in FIG. 14), but these pieces of event information may be further posted on the overall top page 73.

In the present embodiment, a sub-domain is provided for each online mall 10M for the website of each online mall 10M, but a unique domain may be provided. Alternatively, a directory may be provided for each online mall 10M under the same domain or sub-domain, and each website may be constructed in each directory. The same applies to a website of the online shop 10S.

In the present embodiment, the functions shown in FIG. 3 are implemented by the server 2, but may be distributed to a plurality of computers.

In addition, the configurations of the entire or components of each of the online mall system 1, the server 2, the mall terminals 3M, the shop terminals 3S, and the consumer terminals 3C, the processing details, the processing order, the configuration of the database, and the like can be appropriately changed according to the gist of the present invention.

The present embodiment includes the following inventions.

### Appendix 1

a computer program or an online mall operation method that causes a computer accessible to a mall account storage means configured to store a mall account of each of a plurality of online malls, a shop account storage means configured to store a shop account of each of a plurality of online shops that can affiliate with one or more of the plurality of online malls and an affiliation relationship storage means configured to store an affiliation relationship between each of the plurality of online shops and each of the plurality of online malls to execute:
registration processing of generating an account of a new online mall for an applicant wishing to establish the new online mall and registering the new online mall as one of the plurality of online malls by storing the generated account as the mall account in the mall account storage means;
suggesting processing of searching for a satisfying online shop that satisfies a condition designated by an extension-desired online mall among the plurality of online malls from among the plurality of online shops and suggest the satisfying online shop to the extension-desired online mall; and
updating processing of updating the affiliation relationship stored in the affiliation relationship storage means so that the satisfying online shop is affiliated with the extension-desired online mall when both the extension-desired online mall and the satisfying online shop desire an affiliation.

### Appendix 2

The computer program or an online mall operation method according to appendix 1 that causes the computer of appendix 1 to execute:
the registration processing of appendix 1;
a suggesting processing for suggesting for a satisfying online mall that satisfies a condition designated by an affiliation-desired online shop among the plurality of online shops from among the plurality of online malls and suggesting the satisfying online mall to the affiliation-desired online shop;
a second updating suggesting processing for updating the affiliation relationship stored in the affiliation relationship storage means so that the affiliation-desired online shop is affiliated with the satisfying online mall when both the affiliation-desired online shop and the satisfying online mall desire an affiliation.

### Appendix 3

The computer program or an online mall operation method according to appendix 1 that causes the computer of appendix 1 to execute:
the registration processing of appendix 1;
a delivery processing for delivering, to a terminal device of a customer, a page indicating mall information on an accessed online mall designated by the terminal device among the plurality of online malls and shop information on an affiliated online shop affiliated with the accessed online mall among the plurality of online shops, as a mall page of the accessed online mall;
a second delivery processing for delivering, when the affiliated online shop is selected on the mall page by the terminal device, a shop page of the affiliated online shop to the terminal device.

### Appendix 4

An online mall system comprising:
a mall account storage means configured to store a mall account of each of a plurality of online malls;
a shop account storage means configured to store a shop account of each of a plurality of online shops that can affiliate with one or more of the plurality of online malls;
an affiliation relationship storage means configured to store an affiliation relationship between each of the plurality of online shops and each of the plurality of online malls;
a suggesting means configured to search for a satisfying online shop that satisfies a condition designated by an extension-desired online mall among the plurality of online malls from among the plurality of online shops and suggest the satisfying online shop to the extension-desired online mall;
an updating means configured to update the affiliation relationship stored in the affiliation relationship storage means so that the satisfying online shop is affiliated with the extension-desired online mall when both the extension-desired online mall and the satisfying online shop desire an affiliation.

### Appendix 5

An online mall system comprising:
a mall account storage means, a shop account storage means and an affiliation relationship storage means of appendix 1;
a suggesting means configured to search for a satisfying online mall that satisfies a condition designated by an affiliation-desired online shop among the plurality of online shops from among the plurality of online malls and suggest the satisfying online mall to the affiliation-desired online shop; and
a second updating means configured to update the affiliation relationship stored in the affiliation relationship storage means so that the affiliation-desired online shop is affiliated with the satisfying online mall when both the affiliation-desired online shop and the satisfying online mall desire an affiliation.

### Appendix 6

An online mall system comprising:
a mall account storage means, a shop account storage means and an affiliation relationship storage means of appendix 1; and
a delivery means configured to deliver, to a terminal device of a customer, a page indicating mall information on an accessed online mall designated by the terminal device among the plurality of online malls and shop information on an affiliated online shop affiliated with the accessed online mall among the plurality of online shops, as a mall page of the accessed online mall.

### REFERENCE SIGNS LIST 1 online mall system

10M online mall
10S online shop
204 mall affiliate processing module (new mall registering means, updating means, second updating means)
209 shopping page delivery module (delivery means)
3C consumer terminal (terminal device)
210 matching processing module (suggesting means)
501 mall attribute table (mall account storage means)
502 shop attribute table (shop account storage means)
504 affiliation table (affiliation relationship storage means)

1-7. (canceled)

8. An online mall system that implements a plurality of online malls comprising:
a mall account storage portion configured to store a mall account of each of the plurality of online malls;
a shop account storage portion configured to store a shop account of each of a plurality of online shops that can affiliate with one or more of the plurality of online malls; and
an affiliation relationship storage portion configured to store an affiliation relationship between each of the plurality of online shops and each of the plurality of online malls.

9. The online mall system according to claim 8, further comprising:
a suggesting portion configured to search for a satisfying online shop that satisfies a condition specified by an extension-desired online mall among the plurality of online malls from among the plurality of online shops and suggest the satisfying online shop to the extension-desired online mall; and
an updating portion configured to update the affiliation relationship stored in the affiliation relationship storage portion so that the satisfying online shop is affiliated with the extension-desired online mall when both the extension-desired online mall and the satisfying online shop desire an affiliation.

10. The online mall system according to claim 9, further comprising:
a second suggesting portion configured to search for a satisfying online mall that satisfies a condition specified by an affiliation-desired online shop among the plurality of online shops from among the plurality of online malls and suggest the satisfying online mall to the affiliation-desired online shop; and
a second updating portion configured to update the affiliation relationship stored in the affiliation relationship storage portion so that the affiliation-desired online shop is affiliated with the satisfying online mall when both the affiliation-desired online shop and the satisfying online mall desire an affiliation.

11. The online mall system according to claim 10, further comprising:
a new mall registering portion configured to generate an account of a new online mall for an applicant wishing to establish the new online mall and register the new online mall as one of the plurality of online malls by storing the generated account as the mall account in the mall account storage portion.

12. The online mall system according to claim 11, further comprising:
a delivery portion configured to deliver, to a terminal device of a customer, a page indicating mall information on an accessed online mall specified by the terminal device among the plurality of online malls and shop information on an affiliated online shop affiliated with the accessed online mall among the plurality of online shops, as a mall page of the accessed online mall.

13. The online mall system according to claim 12, wherein
the delivery portion further deliver a shop page of the affiliated online shop to the terminal device when the affiliated online shop is selected on the mall page by the terminal device.

14. The online mall system according to claim 13, wherein
the delivery portion delivers, as the mall page, a page indicating held event information as the mall information, the held event information created by the accessed online mall and being about an event which is held by the accessed online mall and is participated in by the affiliated online shop, and delivers, as the shop page, a page indicating participation event information about the event, the participation event information created by the affiliated online shop.

15. The online mall system according to claim 14, wherein
the delivery portion delivers, to the terminal device, a page indicating information of each of the plurality of online malls and information of each of the plurality of online shops as a general page.

16. The online mall system according to claim 9, further comprising:
a new mall registering portion configured to generate an account of a new online mall for an applicant wishing to establish the new online mall and register the new online mall as one of the plurality of online malls by storing the generated account as the mall account in the mall account storage portion.

17. The online mall system according to claim 16, further comprising:
a delivery portion configured to deliver, to a terminal device of a customer, a page indicating mall information on an accessed online mall specified by the terminal device among the plurality of online malls and shop information on an affiliated online shop affiliated with the accessed online mall among the plurality of online shops, as a mall page of the accessed online mall.

18. The online mall system according to claim 8, further comprising:
a suggesting portion configured to search for a satisfying online mall that satisfies a condition specified by an affiliation-desired online shop among the plurality of online shops from among the plurality of online malls and suggest the satisfying online mall to the affiliation-desired online shop; and
an updating portion configured to update the affiliation relationship stored in the affiliation relationship storage portion so that the affiliation-desired online shop is affiliated with the satisfying online mall when both the affiliation-desired online shop and the satisfying online mall desire an affiliation.

19. The online mall system according to claim 18, further comprising:
a new mall registering portion configured to generate an account of a new online mall for an applicant wishing to establish the new online mall and register the new online mall as one of the plurality of online malls by storing the generated account as the mall account in the mall account storage portion.

20. The online mall system according to claim 19, further comprising:
a delivery portion configured to deliver, to a terminal device of a customer, a page indicating mall information on an accessed online mall specified by the terminal device among the plurality of online malls and shop information on an affiliated online shop affiliated with the accessed online mall among the plurality of online shops, as a mall page of the accessed online mall.

21. The online mall system according to claim 8, further comprising:
a new mall registering portion configured to generate an account of a new online mall for an applicant wishing to establish the new online mall and register the new online mall as one of the plurality of online malls by storing the generated account as the mall account in the mall account storage portion.

22. The online mall system according to claim 8, further comprising:
a delivery portion configured to deliver, to a terminal device of a customer, a page indicating mall information on an accessed online mall specified by the terminal device among the plurality of online malls and shop information on an affiliated online shop affiliated with the accessed online mall among the plurality of online shops, as a mall page of the accessed online mall.

23. The online mall system according to claim 22, wherein
the delivery portion further deliver a shop page of the affiliated online shop to the terminal device when the affiliated online shop is selected on the mall page by the terminal device.

24. The online mall system according to claim 22, wherein
the delivery portion delivers, as the mall page, a page indicating held event information as the mall information, the held event information created by the accessed online mall and being about an event which is held by the accessed online mall and is participated in by the affiliated online shop, and delivers, as the shop page, a page indicating participation event information about the event, the participation event information created by the affiliated online shop.

25. The online mall system according to claim 22, further comprising:
the delivery portion delivers, to the terminal device, a page indicating information of each of the plurality of online malls and information of each of the plurality of online shops as a general page.

26. An online mall implementing method for implementing a plurality of online malls comprising:
storing a mall account of each of the plurality of online malls in a mall account storage portion,
storing a shop account of each of a plurality of online shops that can affiliate with one or more of the plurality of online malls in a shop account storage portion, and
storing an affiliation relationship between each of the plurality of online shops and each of the plurality of online malls in an affiliation relationship storage portion.
